(19) United States
(12) Patent Application Publication
(10) Pub. No.: US 2014/0089007 A1
(43) Pub. Date: Mar. 27, 2014

(54) DEVICE TO USER ASSOCIATION IN PHYSIOLOGICAL SENSOR SYSTEMS

(71) Applicant: TOUMAZ TECHNOLOGY LIMITED, Oxfordshire (GB)

(72) Inventors: Calvin Sim, Oxfordshire (GB); Christofer Toumazou, London (GB)

(73) Assignee: TOUMAZ TECHNOLOGY LIMITED, Oxfordshire (GB)

(21) Appl. No.: 14/005,304

(22) PCT Filed: Jan. 9, 2012
(86) PCT No.: PCT/GB2012/050028

§ 371 Date: Nov. 25, 2013

(30) Foreign Application Priority Data
Mar. 14, 2011 (GB) 1104253.8

(51) Int. Cl. G06F 19/00

(52) U.S. Cl. CPC G06F 19/322
USPC 705/3; 705/2

(57) ABSTRACT

A method of associating a wireless sensor device to a user profile in a physiological sensor system, the system comprising a computer records system, at least one base station and a plurality of wireless sensor devices, each of the sensor devices being in contact with a user, the method comprising selecting or defining a user profile on the computer records system for a given user and monitoring signals received at the base station from respective wireless sensor devices. The method further comprises identifying a signal having a response that is characteristic of a pre-defined physiological act and associating the sensor device from which the identified signal is received with the user profile.

### FIELD OF THE INVENTION

This invention relates to a method of associating a wireless sensor device to a user profile and a physiological sensor system incorporating the same.

### BACKGROUND TO THE INVENTION

The technology is now available to implement remote wireless monitoring and surveillance of individuals through the use of one or more personalised body-worn sensor devices that communicate with and connect to a central server wirelessly via a gateway device. A healthcare monitoring system of this type is described in the applicants' earlier UK patent application, GB2458139. In such systems, the central server includes elements for capturing and tracking personal details of many registered users that are spatially distributed over an area so as to provide online, personalised services to each of the users regardless of their location, so long as the users are able to connect and communicate with the central server wherever they are. In such systems, the sensor device (node) is physically worn or attached to the body of an individual user to capture the user's vital sign information, while a base-station or gateway device is detached from the sensor device.

Typically, it is assumed that for comfort and portability, the sensor device should be as small, and as unobtrusive as possible so that it can be worn without (or with minimal) discomfort to the user. This requirement for wearability imposes strict restrictions in the form-factor and consequently severely limits the power consumption, features and storage ability of the sensor device. Hence, a base-station node may play an important role in wirelessly relaying the captured information from the sensor device to another device that is not as restrained in terms of form-factor or power consumption, and that is better suited for storing, processing, or analysing the data so as to provide value to the user wearing such vital signs monitoring equipment.

The separation of functionality between the sensor device and the base-station makes most sense when the communications between the two nodes are wireless. The wireless nature of the communications between the sensor device and the base-station provides untethered convenience, freedom and mobility to the user in going about his or her everyday activities in a way that wired forms of communications are unable to achieve.

To facilitate correct matching between the sensed, captured physiological parameters (such as but not limited to physical activity or vital signs of an individual from the wirelessly transmitting/transceiving device and the remote server) it is necessary to associate the body-worn sensing device with the registered, online user information to ensure that the captured and wirelessly transmitted data from the body-worn sensing device can be correctly matched to the registered user.

The association between one or more wireless body-worn device and a registered online user profile is typically performed post-manufacture such that there is no correlation between any particular (existing or to be manufactured) body-worn sensing device and (existing or to be) registered user profiles and, ideally, would be carried out by the wearer of the device upon first-time use of the sensing device or in future, as the need arises, with minimal effort.

Fundamentally, the association is achieved by creating a relationship between a unique number identifier (ID) on the body-worn device and the online user profile of the wearer. Consequently, any process of association requires the unique identifier to be transmitted correctly to the central server and the central server has to have sufficient information to associate that number with the user profile of the registered user that is wearing the device. The transmission of the unique identifier to the central server may be transparent, seamless and invisible to the wearer by transmitting this within the same wireless radio frequency channel allocated for transmitting sensor information or control data.

However, the lack of physical attachment between the sensor device and the base-station gives rise to a number of issues related to how to correctly associate and link the sensor device to the base-station and how to protect the vital signs (or other) information that is wirelessly relayed from the individual user to the base-station at the base-station end of the network. This is particularly important when there are one or more alternative compatible sensor devices or users in the vicinity that are capable of communicating with said network elements but are not required to do so.

In the case where there is only one user that can provide such a unique identifier to the system, such as when there are no other users in the vicinity of an available gateway device which are connected or trying to connect to the central server, this is relatively straightforward. However, given the wireless nature of the device and in the context of devices having sufficient wireless range so as to have overlapping areas of coverage between sensor devices and/or their gateway devices, with sufficient users, there would be many possible scenarios where it would be difficult or perhaps impossible for the central server to distinguish unique identifiers of body-worn sensor devices that may be registered to more than one online user profiles without further information allowing it to distinguish and correctly associate the device with the wearer.

One way of achieving the above is to have the user log on to a central server and, within the logged-in state of the central server, provide the unique identifier as a series of symbols to the central server. All the elements required for association would then be present to successfully achieve association. The correlation in time and user state of the central server between the wirelessly received series of symbols and the user-input series of symbols would provide strong evidence to the central server to distinguish and correctly perform the association between the wearer's user profile and the device. However, this method is cumbersome and, in order to support a large quantity of devices, the method would require the series of symbols to be sufficiently long and complex.

The above method may be made less cumbersome by relying on a simpler capture method such as through the user initiated scanning of a bar-coded unique identifier that is pre-labelled on the device or its associated packaging. While this would reduce the effort required by the wearer to associate the device, the system for association would need to incorporate functionality for scanning barcodes, such as a bar-code scanner or a digital camera. Such an improvement would therefore come at the expense of an increase in the minimum requirements and cost of the system.

Alternatively, a user initiated signal required for correlating and matching with the unique identifier may be provided by tapping a button or similar device to trigger a user-initiated independent signal to the central server, within a small time window whilst the user is logged in and in the process of associating a new device. This particular approach simplifies the system requirements for the device to user association.

However, it would require a separate user interface for triggering the association signal. Moreover, such an interface may be so simple that it may be prone to unintentional triggering which may interfere with the association procedure, particularly where there is more than one user/body-worn device within the vicinity of a gateway.

It is therefore an aim of the present invention to provide a method of associating a wireless sensor device to a user profile in a physiological sensor system that addresses at least some of the aforementioned problems.

### SUMMARY OF THE INVENTION

According to a first aspect of the present invention there is provided a method of associating a wireless sensor device to a user profile in a physiological sensor system, the system comprising a computer records system, at least one base station and a plurality of wireless sensor devices, each of the sensor devices being in contact with a user, the method comprising:
selecting or defining a user profile on the computer records system for a given user;
monitoring signals received at the base station from respective wireless sensor devices;
identifying a signal containing a response that is characteristic of a pre-defined physiological act; and
associating the sensor device from which the identified signal is received with the user profile.

Embodiments of the present invention therefore provide a quick and simple method for associating a device with a user, which does not require manual (e.g. keyboard or touchscreen) entry or any additional interface hardware for the sensor device or the computer records system (i.e. system gateway). Accordingly, the present invention can negate the need for optical barcode scanning or a separate push-button (or similar device) to generate a user-initiated, independent trigger signal, for association of a sensor device with a user profile, during an association window. It is therefore believed that the present invention provides an intuitive means for performing device association.

The physiological sensor system may be constituted by a healthcare monitoring system. In other embodiments of the invention the physiological sensor system may be configured for health and/or fitness gaming applications, where elements of the gaming interface include vital signs sensors and the game incorporates a user profile that is stored in a computer records system provided locally or centrally on a cloud.

The method may further comprise wirelessly linking the base station to a first wireless sensor device, determining whether a signal received from said first wireless sensor device contains a response that is characteristic of the pre-defined physiological act, and terminating the link with said first wireless sensor device if the signal does not contain said response so that the base station is available to link with a second or further wireless sensor device to identify the device to be associated with the given user.

The physiological sensor system may be configured as a single user (point-to-point) network. In which case, each sensor device may be configured to only associate with a single one of a plurality of base-stations, each base-station comprising the computer records system or a portion thereof. Given the one-to-one nature of association between the sensor devices and the base-stations, the base-stations may be configured as portable devices which are intended to travel with the user.

In this single-user type of organisation, the each base-station may comprise a unit for acquiring, storing, processing and analysing data received from its associated sensor device and/or directly from the user. The base-stations may therefore be configured for gathering vital signs information (from the sensor devices) in addition to user-specified information such as height, weight, age, known physiological conditions and habits (e.g. whether the user is a smoker). As such the base-station may possess personal and intimate information about the user, which should be protected from unauthorised access. Furthermore, the base station may comprise a user interface which may be configured to elicit user input (e.g. to provide information or adjust settings or preferences) and/or to provide feedback on a user's well-being based on the data acquired from the sensor device.

In another embodiment of the invention, the physiological sensor system may be configured as a cloud-based service provision (e.g. with multiple sensor devices and base-stations distributed across a network such as the Internet). In which case, each sensor device may be configured to only associate with a single one of a plurality of base-stations and each base-station may be configured to communicate with one or more central servers within the cloud. As above, given the one-to-one nature of association between the sensor devices and the base-stations, the base-stations may be configured as portable devices which are intended to travel with the user.

In this cloud-based organisation, the base-station may comprise an Internet gateway and which serves as a bridge to relay information from the sensor device to the cloud-based servers. The base-station may also comprise processing units configured to perform a set (or subset) of data-processing tasks so as to optimise the trade-offs related to costs associated with Internet bandwidth, processing power and storage on the base-station or cloud servers. In this type of system it is likely, but not an absolute requirement, that there is a one-to-one relationship between the sensor device and the base-station. In some embodiments, the sensor devices may relay information via more than one base-station. In which case, factors such as the level of trust (e.g. through an existing or higher-level relationship) and security between the sensor device and the base-station will likely need to be addressed.

Furthermore, while there is no specific requirement that the base-station has any long term retention of detailed information of the user (although, this may still occur, to provide a reasonable level of service both online when the base-station is connected to the cloud servers, and offline when there is no connection), it would be highly likely and sensible to expect that the user would interact with the system through some form of user interface that would expose his/her user information and provide feedback on his/her well-being through an Internet-enabled device, such as the base-station. Accordingly, the base-station may comprise a user interface and the computer records system or a portion thereof may be stored on the base-station or the cloud servers and may be accessible (to some degree) through the base-station.

In a further embodiment of the invention, the physiological sensor system may be configured as an enterprise system (e.g. with multiple sensor devices and base-stations distributed across a local area or private network). In which case, each sensor device may be configured to associate with (and communicate with) a nearest of a plurality of base-stations (or the base-station with which the sensor device has the strongest connection/signal) and each base-station may be configured to communicate with one or more central servers provided within the network.

In the case of such an enterprise system, the base-station may be responsible for relaying information from the sensor device to the central servers for data storage, processing and analysis. Each base-station may be configured to accept communications from any recognised sensor device whenever possible (note, it may not always be possible for the base-station to accept communications, for example, when there is channel congestion with too many sensor devices trying to communicate at the same time over a limited amount of available frequency spectrum). Consequently, the base-stations may comprise no (or very limited) processing and/or long-term storage capabilities as the priority may be to pass on the information from the sensor devices to the central servers as soon as possible. The base-stations may therefore not retain detailed information regarding the users. Instead, the user profiles may be stored and managed by the central servers. In which case, the base-stations may not comprise a user interface which is directly accessible by the user.

While issues related to association, linking, and protection of the communications between the sensor devices and the base-stations are common to all three types of network organisations described above (single user, cloud-based service, enterprise system), the differences in characteristics of the types of networks suggest that the exact nature of the issues for each of the network scenarios would differ and hence, their solutions might also differ.

For example, in the case of the enterprise type of network, as neither the sensor device nor the base-station would typically have a user interface to enable the user being monitored to view or edit personal information (although a user-interface to the central servers may be provided for an IT administrator), the issue of leakage of sensitive, personal and identifiable user information from the sensor device or base-station would be limited to the cases where there is a determined hacker. This can be contrasted to both the single-user and cloud-based scenarios where sensitive, personal and identifiable user information might very likely be available directly through the base-stations.

Some aspects of the present invention therefore focus on systems where a user (whose vital signs/physiological characteristics are being acquired) would also be actively interacting with the system to derive information and value from it. Such cases would typically exclude enterprise type of networks where there is generally no user interface associated with the sensor device or base-station.

Particular embodiments of the present invention address issues around providing secure and private communications between a sensor device and a base station. This is of particular importance where the base-stations comprise a user interface through which user information may be entered, exposed and/or edited by the user. In such embodiments, each base-station may further comprise an Internet gateway, a processing element and/or a storage element.

More specifically, each base-station may comprise a user interface configured for gathering user information from the user and/or for presenting user information (e.g. containing or derived from sensed information) to the user. Each base-station may be configured to match physiological data received from the sensor device with the user profile. Each base-station and sensor device may be configured to mutually identify each other and correctly communicate wirelessly with each other. Each base-station and sensor device may be configured to reject all other compatible and active devices that try to communicate with it (regardless if such devices are other base-stations or sensor devices), if such devices are not associated with the given user profile.

It is important to note that there may exist an asymmetry in the system requirements, in that, while the user would certainly want to interact with the correct base-station, it may be impossible to distinguish between a number of active sensor devices that are trying to communicate with a given base-station unless the base-station has a priori knowledge of a distinguishing characteristic of the sensor device. In some embodiments, the target sensor device may provide the base-station with clear evidence that it is indeed the target sensor device on the target user, rather than any other sensor device that happens to be in an associative mode and which is within the range of the base-station. Furthermore, it may be the case that there is an asymmetry in the computational power of the sensor device (which is typically lower) when compared to the base-station.

Embodiments of the invention may therefore comprise a method for authenticating and/or protecting communications between the base-station and the sensor devices.

The method may comprise an activation stage during which the base-station may link with one or more of the sensor devices. Upon successful linkage, the base-station device may securely exchange pairing keys with each of the connected sensor devices in turn.

The method according to the first aspect of the invention may comprise the step of the computer system (e.g. base-station) generating a signal for the given user to perform the physiological act. This step may comprise the computer system generating a visual and/or audio instruction to the user to perform the physiological act.

The method may comprise the step of the computer system monitoring the signals for a pre-defined time window after the given user has been selected or defined. The computer system may provide a signal to indicate the start and/or end of the time window. The method may further comprise the step of indicating that no association has been made, if the time window elapses before the signal having a response characteristic of the physiological act, is identified.

The user profile may comprise a store of data and/or an analysis of data from the associated sensor device.

The physiological act may comprise the performance of one or more gestures or movements.

In a particular embodiment, the physiological act may comprise the sensor device being placed in a first orientation for a given duration. In some embodiments, the physiological act may further comprise the sensor device being placed in a second orientation for a given duration. The second orientation may be inverted with respect to the first orientation. The second orientation may be offset by 90°, 180° or 270° with respect to the first orientation.

In embodiments of the invention, the sensor devices may be configured to monitor the user's heartbeat and/or respiration. More specifically, the sensor devices may be configured to generate signals representative of an electrocardiogram (ECG). The ECG signals may comprise a so-called QRS complex corresponding to the depolarization of the right and left ventricles of the heart.

In one embodiment, the response that is characteristic of the physiological act may comprise an observable change in the QRS complex. For example, the response that is characteristic of the physiological act may comprise a change in the orientation of the QRS complex (as would be observed in the case when the selected user is instructed to change the orientation of their ECG sensor device).

In another embodiment, the physiological act may comprise the taking of alternate deep and shallow breaths. In which case, the sensor devices may comprise respiration sensing circuitry (e.g. employing impedance pneumography). In one embodiment, the sensor devices may be configured to generate signals representative of a user's respiration and may be further configured to generate signals representative of an electrocardiogram (ECG). The step of identifying a signal having a response characteristic of the physiological act may comprise correlating the respiration signals with the ECG signals (which may be processed to indicate an ECG-derived respiration pattern). If the level of correlation is high, and the appropriate intervals between deep and shallow breaths can be distinguished, the system may, with a high level of confidence, interpret the physiological signals as a user-initiated trigger for device association.

In certain embodiments, the physiological act may comprise standing up and/or sitting down. In other embodiments, the physiological act may comprise jumping up and down. In further embodiments, the physiological act may comprise holding the user's breath (e.g. for a pre-defined duration) or tapping the sensor device a pre-determined number of times.

In some embodiments, the wireless sensor devices may encrypt the signal containing the response that is characteristic of the pre-defined physiological act prior to transmitting the signal to the base station.

The base-station may transmit a segment of the identified signal back to the sensor device and the sensor device may check that the segment received from the base station matches a corresponding segment of data stored by the sensor device so as to establish that the sensor device is communicating with the desired base station.

The sensor device may also transmit a unique identifier to the base-station, which constitutes a shared key for use in future communications between the base-station and the sensor device.

In the embodiment which the sensor device is tapped a pre-determined number of times, the base station may randomly generate a small counting number, x (for example, any number between 1 and N) and may display a request on the base station's user interface for the user to tap x times on the user's sensor device. The user may then tap their sensor device x number of times to create a distinct signal signature due to motion artefacts generated from the tapping. The sensor device may then encrypt the raw sensor data (which encodes the number of taps by the user) and may transmit the data back to the base-station. The base-station may then decrypt the raw sensor data and may run an appropriate algorithm to decode the number of taps, x′ conveyed by the data. If the number of taps matches the initially generated small counting number, such that x′=x, then there is a high level of confidence that the sensor device that provided the data is the correct one to associate with, rather than any other connected sensor device.

The base-station may then splice up the decrypted raw sensor data into a fixed number of segments corresponding to N. The base station may then transmit the unencrypted x^{th} segment of the raw sensor data back to the sensor device. The sensor device may then be able to match the raw sensor data to the x^{th} segment of raw data that it has retained in its local memory. If the x^{th} segment matches, the sensor device may (with a high level of confidence) know that it is communicating with the desired base-station. The sensor device may then encrypt a unique identifier, such as an on-chip unique chip ID, or an identifier derived from the digitised sensor interface input, and may transmit the identifier to the base-station. The base-station may receive the encrypted unique identifier and may decrypt it using its own pair-wise key. This unique identifier may from now on be the shared key between the two devices (i.e. the sensor device and the base station) which is used for any communications with each other for a given duration or session.

The step of identifying the signal having the response that is characteristic of the physiological act may comprise correlating each of the monitored signals with an expected response characteristic associated with the physiological act to determine the signal having the closest response to that expected.

It will be understood that the step of identifying a signal having a response that is characteristic of the physiological act may comprise detecting a pre-defined pattern in the signal representing sensed data so as to associate the selected user's sensor device with the corresponding user profile.

The method may comprise placing the selected user's sensor device in an association mode. The sensor devices may be configured to operate in an association mode upon initial start-up of the device.

The step of defining a user profile may comprise creating a new user profile within the system. The user profiles may be stored in a memory or database and may be accessible remotely, for example, via an on-line gateway or handheld (e.g. base station) device.

According to a second aspect of the present invention there is provided a physiological sensor system comprising:
a plurality of wireless sensor devices, each of which is configured to be placed in contact with a user to produce a signal representative of a physiological act; and
a computer records system configured to:
   permit an operator to select or define a user profile for a given user; and at least one base station configured to:
   monitor signals received from respective sensor devices;
   identify a signal having a response that is characteristic of a pre-defined physiological act; and
   associate the sensor device from which the identified signal is received with the user profile.

The base station may comprise a user interface configured for selecting/defining the user profile and/or for generating a signal for the given user to perform the pre-defined physiological act.

The base station may comprise a correlator configured for identifying the signal having a response that is characteristic of the pre-defined physiological act.

The computer records system may comprise a memory or database of user profiles and a module for creating new user profiles.

The sensor devices may be configured to monitor a user's heartbeat and/or respiration. The sensor devices may be configured to generate signals representative of an electrocardiogram (ECG). Additionally or alternatively, the sensor devices may be configured for impedance pneumography.

The sensor devices may be configured as wearable wireless devices and may comprise radio frequency transmitters or transceivers.

In a particular embodiment, the sensor devices may be configured low-power battery-operated disposable devices.

According to a third aspect of the present invention there is provided a base station for a physiological sensor system, the base station configured to:
monitor signals received from a plurality of sensor devices attached to users;
identify a signal having a response that is characteristic of a pre-defined physiological act; and
associate the sensor device from which the identified signal is received with a given user profile.

The features described above in relation to one aspect of the invention may equally be applied to other aspects of the invention and vice versa.

### BRIEF DESCRIPTION OF THE DRAWINGS

The various aspects of the invention will now be described in relation to the accompanying drawings in which:

FIG. 1 shows flow diagram for a method of associating a wireless sensor device to a user profile in a physiological sensor system; and

FIG. 2 shows a block diagram of a physiological sensor system for carrying out the method of FIG. 1.

### DETAILED DESCRIPTION OF CERTAIN EMBODIMENTS

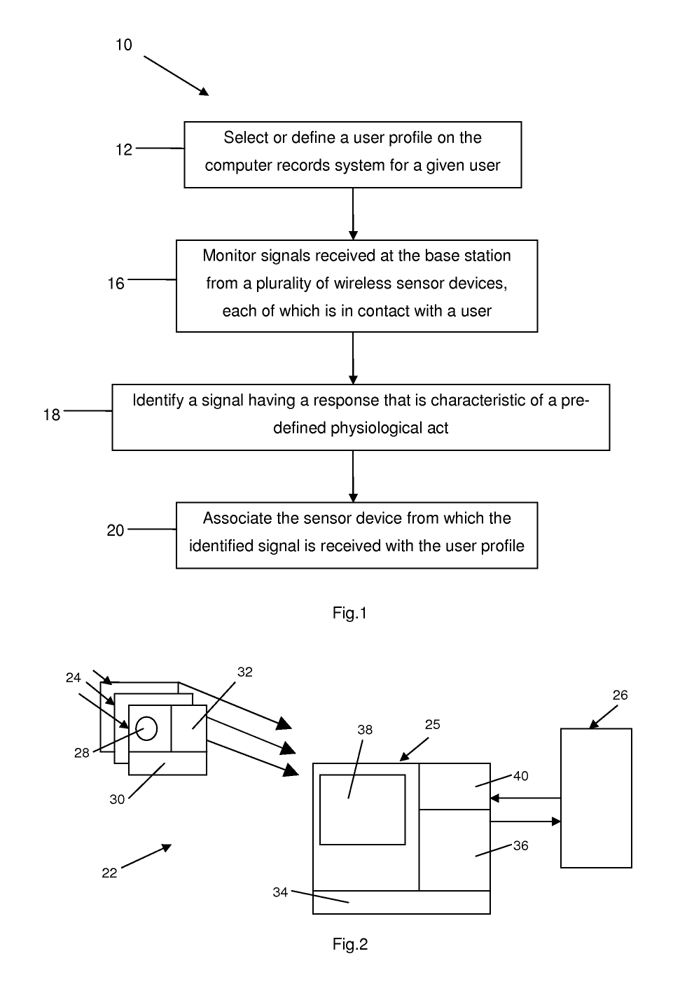

FIG. 1 illustrates a method 10 of associating a wireless sensor device to a user profile in a physiological (e.g. healthcare) sensor system, the system comprising a computer records system at least one base station and a plurality of wireless sensor devices, each of the sensor devices being in contact with (e.g. attached to) a user, in accordance with an embodiment of the present invention. The method comprises a first step 12 of selecting or defining a user profile on the computer records system for a given user and a second step 16 of monitoring signals received at the base station from respective wireless sensor devices. The method further comprises a third step 18 of identifying a signal having a response that is characteristic of a pre-defined physiological act and a fourth step 20 of associating the sensor device from which the identified signal is received with the user profile.

In a particular embodiment of the invention, the method 10 is carried out by a physiological (healthcare) sensor system 22, such as that illustrated in FIG. 2. Thus, the system comprises a plurality of wireless sensor devices 24, each configured for attachment to a user to produce a signal representative of a physiological effect, a base station 25 and a central computer records system which may be provided on a cloud server 26. In other embodiments, the computer records system may be provided within the base-station 25.

The healthcare sensor system 22 may be configured for use in a hospital or home healthcare environment and the sensor devices 24 may be configured for monitoring a user's heartbeat. The sensor devices 24 may therefore comprise a sensor element 28, a processor 30 and a transceiver 32 for communicating with the computer records system 26. Similarly, the base station 25 may comprise a processor 34, a memory 36, a user interface 38 and a transceiver 40.

In a particular embodiment of the invention, users are required to be registered online with the computer records system 26. When a new user wishes to join the system (or a new sensor device 24 is required to be associated with an existing user) it is necessary to input and select the required user profile from the computer records system 26. This step may be performed by the user logging onto the computer records system 26 through the base station 25. The sensor device 24 may then be turned on for the first time (or after a full factory-default reset) and may begin to operate in an association mode. In such a mode, the sensor device 24 may be configured to take a pre-determined set of readings from the sensor element 28 and/or to send a particular set of information to the base station 25. The information relayed to the base station 25 may include an identification number/code (ID) for the sensor device 24 in addition to a signal representing the sensed data.

Once the user profile to be associated with the sensor device 24 has been selected, the base station 25 will request, via the user interface 38, that the user performs a particular set of movements or gestures. In this embodiment, the user will be instructed to wear the sensor device 24 in one orientation such that a QRS component of an ECG signal generated by the sensor device 24 is oriented one way for a period of time, and then to wear the sensor device 24 upside down so that the QRS component is oriented in an inverted way for a separate and independent period of time. This information is relayed to the base station 25 by the transceiver 32.

The base station 25 will then interpret the signal sent by the sensor device 24 (and any other signals it receives from other neighbouring sensor devices 24) to determine whether any of the signals include a clear signature which is characteristic of the physiological activity (i.e. where the QRS component is inverted during a specified time period). If there is a high level of correlation between the two QRS components (i.e. heartbeats) received from one of the sensor devices 24, but wherein the components are inverted for a given duration, the system will interpret this as a user-initiated trigger for device association, with a high degree of certainty. Accordingly, the ID of the sensor device 24 generating the inverted ECG signal will be associated with the selected user profile such that all subsequent data obtained from the sensor device 24 can be related to that user.

Embodiments of the invention therefore provide a quick, simple and cost-effective method for associating a device with a user in a healthcare sensor system.

It will also be appreciated by persons skilled in the art that various modifications may be made to the above embodiments without departing from the scope of the present invention. For example, features described in relation to one embodiment may be incorporated into another embodiment or vice versa.

1. A method of associating a wireless sensor device with a user profile in a physiological sensor system, the system comprising a computer records system, at least one base station and a plurality of wireless sensor devices, each of the sensor devices being in contact with a user, the method comprising:
selecting or defining a user profile on the computer records system for a given user;
monitoring signals received at the base station from respective wireless sensor devices;
identifying a signal containing a response that is characteristic of a pre-defined physiological act; and
associating the sensor device from which the identified signal is received with the user profile.

2. The method according to claim 1 further comprising wirelessly linking the base station to a first wireless sensor device, determining whether a signal received from said first wireless sensor device contains a response that is characteristic of the pre-defined physiological act, and terminating the link with said first wireless sensor device if the signal does not contain said response so that the base station is available to link with a second or further wireless sensor device to identify the device to be associated with the given user.

3. The method according to claim 1 wherein the computer system generates a signal for the given user to perform said act.

4. The method according to claim 1 wherein the computer system monitors the signals for a pre-defined time window after the given user has been selected or defined.

5. The method according to claim 4 wherein the computer system provides a signal to indicate the start and/or end of the time window.

6. The method according to claim 1 where the user profile comprises a store of data and/or an analysis of data from the associated sensor device.

7. The method according to claim 1 wherein the physiological act comprises the sensor device being tapped a pre-determined number of times.

8. The method according to claim 1 wherein the physiological act comprises the sensor device being placed in a first orientation for a given duration and then being placed in a second orientation for a given duration.

9. The method according to claim 1 wherein the sensor devices are configured to generate signals representative of an electrocardiogram (ECG).

10. The method according to claim 9 wherein the response that is characteristic of the physiological act comprises an observable change in a QRS complex of the ECG.

11. The method according to claim 1 wherein the physiological act comprises the taking of alternate deep and shallow breaths and the sensor devices are configured to generate signals representative of a user's respiration and to further generate signals representative of an electrocardiogram (ECG).

12. The method according to claim 11 wherein the step of identifying a signal having a response that is characteristic of the physiological act comprises correlating the respiration signals with the ECG signals.

13. The method according to claim 1 further comprising the wireless sensor devices encrypting the signal containing the response that is characteristic of the pre-defined physiological act prior to transmitting the signal to the base station.

14. The method according to claim 1 wherein the step of identifying the signal having the response that is characteristic of the physiological act comprises correlating each of the monitored signals with an expected response characteristic associated with the physiological act to determine the signal having the closest response to that expected.

15. The method according to claim 4 further comprising the step of indicating that no association has been made, if the time window elapses before the signal having a response that is characteristic of the physiological effect, is identified.

16. The method according to claim 1 further comprising a method for authenticating and/or protecting communications between the base-station and the sensor devices.

17. The method according to claim 16 wherein the base-station transmits a segment of the identified signal back to the sensor device and the sensor device checks that the segment received from the base station matches a corresponding segment of data stored by the sensor device so as to establish that the sensor device is communicating with the desired base station.

18. The method according to claim 17 wherein the sensor device transmits a unique identifier to the base-station, the unique identifier constituting a shared key for use in future communications between the base-station and the sensor device.

19. A physiological sensor system comprising:
a plurality of wireless sensor devices, each of which is configured to be placed in contact with a user to produce a signal representative of a physiological act;
a computer records system configured to:
permit an operator to select or define a user profile for a given user; and
at least one base station configured to:
monitor signals received from respective sensor devices;
identify a signal having a response that is characteristic of a pre-defined physiological act; and
associate the sensor device from which the identified signal is received with the user profile.

20. The physiological sensor system of claim 19 configured as a healthcare monitoring system or a health and/or fitness gaming system.

21. A base station for a physiological sensor system, the base station configured to:
monitor signals received from a plurality of sensor devices attached to users;
identify a signal having a response that is characteristic of a pre-defined physiological act; and
associate the sensor device from which the identified signal is received with a given user profile.

22-24. (canceled)
